(19) United States
(12) Patent Application Publication
(10) Pub. No.: US 2023/0269658 A1
(43) Pub. Date: Aug. 24, 2023

(54) NETWORK SLICING MANAGEMENT METHOD AND SYSTEM, AND COMPUTER READABLE STORAGE MEDIUM

(71) Applicant: ZTE Corporation, Shenzhen (CN)

(72) Inventor: Zitao Xue, Shenzhen (CN)

(73) Assignee: ZTE Corporation, Shenzhen (CN)

(21) Appl. No.: 18/020,237

(22) PCT Filed: Jul. 6, 2021
(86) PCT No.: PCT/CN2021/104789

§ 371 Date: Feb. 7, 2023

(30) Foreign Application Priority Data
Aug. 27, 2020 (CN) 202010876590.X

(51) Int. Cl. H04W 48/16; H04W 48/08

(52) U.S. Cl. CPC H04W 48/16; H04W 48/08

(57) ABSTRACT

Disclosed are a network slice management method and system, and a computer-readable storage medium. The network slice management method may include: acquiring a second network slice rule; establishing a connection with a user equipment (UE); and sending the second network slice rule to the UE.

### CROSS-REFERENCE TO RELATED APPLICATION

This application is a national stage filing under 35 U.S.C. § 371 of international application number PCT/CN2021/104789, filed Jul. 6, 2021, which claims priority to Chinese patent application No. 202010876590.X, filed Aug. 27, 2020. The contents of these applications are incorporated herein by reference in their entirety.

### TECHNICAL FIELD

Embodiments of the present disclosure relate to, but not limited to, the technical field of network communication, and in particular to a network slice management method and system, and a computer-readable storage medium.

### BACKGROUND

As a basis for 5G applications, the 5G slicing technology is receiving more and more attention from all links in the industrial chain. The 5G slicing technology is a platform technology for the implementation of 5G applications, so it is easy to foresee that in the future, 5G slicing will become the most valued link in the 5G-related industrial chain as well as a focus of competition among various vendors.

In some cases, the network slicing function defined in the current 3rd Generation Partnership Project (3GPP) protocol system is based on the upgrade of a core network to 5G Core Network (5GC), with a UE Route Selection Policy (URSP) being issued to User Equipments (UEs) by a Policy Control Function (PCF) which is a network element of a control plane of the core network. Therefore, the 3GPP Non-Access Stratum (NAS) layer protocol is adopted as a management and update rule for its network slice rules, that is, all the network slice rules are based on the NAS layer protocol, which makes changes related to upgrade and maintenance complicated and inflexible.

The UE is divided into two aspects at software and hardware logic layers, i.e., an Application Process (AP) and a modem. Chip vendors generally open all the codes on the AP side, but only partially open or even refuse to open the codes on the modem side, and the progress of related development is slow. However, the current URSP rule of 3GPP is equivalent to completely placing a 5G network slice selection policy on the modem side, while the application of the 5G network slice rules is on the AP side. As a result, the distance between them at the logic layers is too far, which makes the customization of scenarios according to requirements of customers very inconvenient and the implementation of many requirements of customers in actual vertical industries very difficult.

### SUMMARY

The following is a summary of the topic described in detail herein. This summary is not intended to limit the protection scope of the claims.

Embodiments of the present disclosure provide a network slice management method, a network slice management system, and a computer-readable storage medium.

In accordance with an aspect of the present disclosure, an embodiment provides a network slice management method, which is applied to a slice management server, and the slice management server is arranged on a user plane of a core network. The method may include: acquiring a second network slice rule; establish a connection with a User Equipment (UE); and sending the second network slice rule to the UE.

In accordance with an aspect of the present disclosure, an embodiment provides a network slice management method, which is applied to a UE. The method may include: establishing a connection with a slice management server arranged on a user plane of a core network; and receiving a second network slice rule sent by the slice management server.

In accordance with an aspect of the present disclosure, an embodiment provides a network slice management system. The system may include a memory, a processor, and a computer program stored in the memory and executable by the processor which, when executed by the processor, causes the processor to implement the network slice management methods described above.

In accordance with an aspect of the present disclosure, an embodiment provides a computer-readable storage medium, storing a computer-executable program which, when executed by a computer, causes the computer to implement the methods described above.

Other features and advantages of the present disclosure will be set forth in the following description, and will partially become apparent from the description, or may be understood by practicing the present disclosure. The objective and other advantages of the present disclosure can be achieved and acquired by the structure particularly specified in the description, the claims and the accompanying drawings.

### BRIEF DESCRIPTION OF DRAWINGS

The accompanying drawings are intended to provide a further understanding of the technical scheme of the present disclosure and constitute part of the description. The accompanying drawings are used together with the embodiments of the present disclosure to illustrate the technical scheme of the present disclosure, and do not constitute a limitation to the technical scheme of the present disclosure.

FIG. 1A is a flowchart of a network slice management method according to an embodiment of the present disclosure;

FIG. 1B is a schematic diagram of a network architecture according to an embodiment of the present disclosure;

FIG. 1C is a flowchart of a network slice management method according to another embodiment of the present disclosure;

FIG. 1D is a flowchart of a network slice management method according to another embodiment of the present disclosure;

FIG. 2 is a flowchart of a network slice management method according to an embodiment of the present disclosure; and

FIG. 3 is a schematic structural diagram of a network slice management system according to an embodiment of the present disclosure.

### DETAILED DESCRIPTION

In order to make the objective, technical scheme and advantages of the present disclosure clear, the present disclosure will be further described in detail below with reference to the accompanying drawings and embodiments. It should be understood that the specific embodiments described herein are merely used to illustrate the present disclosure, and are not intended to limit the present disclosure.

It should be understood that in the description of the embodiments of the present disclosure, the term “plurality of” (or multiple) means at least two, the prefix such as “greater than”, “less than”, “exceed” or variants thereof before a number or series of numbers is understood to exclude this number. If used herein, the terms such as “first” and “second” are merely used for distinguishing technical features, and are not intended to indicate or imply relative importance, or implicitly point out the number of the indicated technical features, or implicitly point out a precedence order of the indicated technical features.

As a basis for 5G applications, the 5G slicing technology is receiving more and more attention from all links in the industrial chain. The 5G slicing technology is a platform technology for the implementation of 5G applications, so it is easy to foresee that in the future, 5G slicing will become the most valued link in the 5G-related industrial chain as well as a focus of competition among various vendors.

In some cases, the network slicing function defined in the current 3rd Generation Partnership Project (3GPP) protocol system is based on the upgrade of a core network to 5G Core Network (5GC), with a UE Route Selection Policy (URSP) being issued to User Equipments (UEs) by a Policy Control Function (PCF) which is a network element of a control plane of the core network. Therefore, the 3GPP Non-Access Stratum (NAS) layer protocol is adopted as a management and update rule for its network slice rules, that is, all the network slice rules are based on the NAS layer protocol, which makes changes related to upgrade and maintenance complicated and inflexible.

The UE is divided into two aspects at software and hardware logic layers, i.e., an Application Process (AP) and a modem. Chip vendors generally open all the codes on the AP side, but only partially open or even refuse to open the codes on the modem side, and the progress of related development is slow. However, the current URSP rule of 3GPP is equivalent to completely placing a 5G network slice selection policy on the modem side, while the application of the 5G network slice rules is on the AP side. As a result, the distance between them at the logic layers is too far, which makes the customization of scenarios according to requirements of customers very inconvenient and the implementation of many requirements of customers in actual vertical industries very difficult.

Embodiments of the present disclosure provide a network slice management method, a network slice management system, and a computer-readable storage medium. By adding a slice management server on a user plane of a core network, the slice management server establishes a connection with a User Equipment (UE), and sends a new version of network slice rule to the UE. Based on this, compared with an existing core network architecture of 3GPP, by adding the slice management server on the user plane of the core network, and using the slice management server to control the network slice rule of the UE, a 5G slicing management function can be carried out by the user plane, and thus a 5G slice selection policy can be placed on the AP side, to facilitate a quick coordination between a terminal vendor, an operator and a customer for quick completion of requirement customization of a 5G vertical industry.

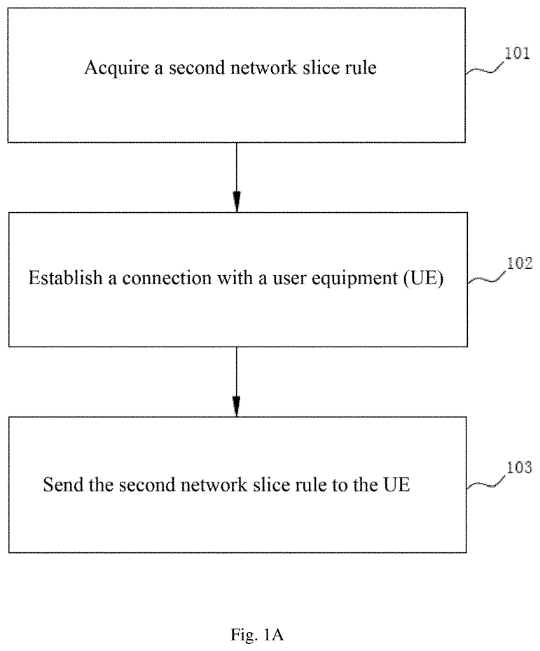

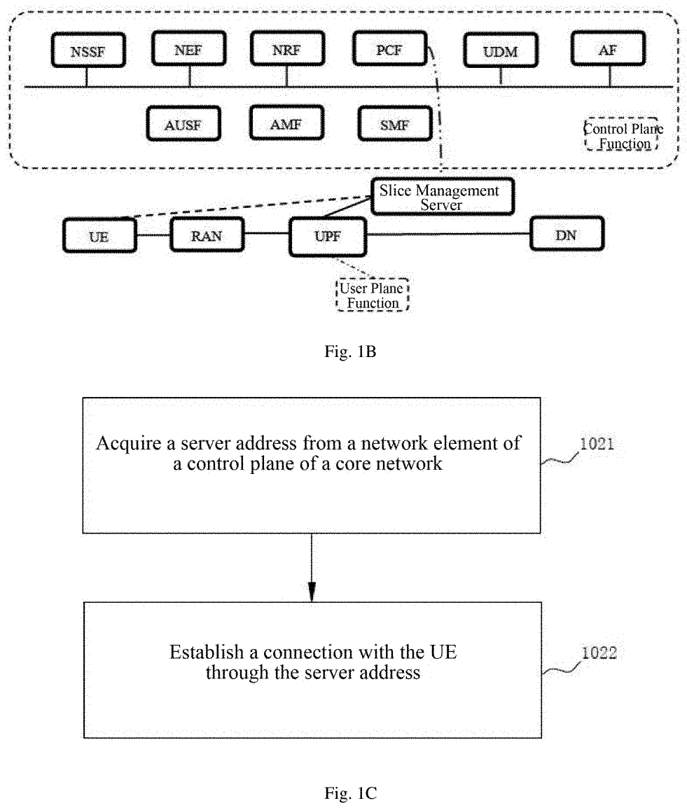

FIG. 1A is a flowchart of a network slice management method according to an embodiment of the present disclosure. As shown in FIG. 1A, the network slice management method is applied to a slice management server, which is arranged on a user plane of a core network. The network slice management method includes, but not limited to, the following steps S101 to S103.

At S101, a second network slice rule is acquired.

At S102, a connection is established with a user equipment (UE).

At S103, the second network slice rule is sent to the UE.

In an embodiment, the slice management server acquires a second network slice rule, establishes a connection with a User Equipment (UE), and sends the second network slice rule to the UE. The second network slice rule refers to a new version of network slice rule acquired by the slice management server. In this embodiment, as shown in FIG. 1B, the slice management server may be separately arranged on the user plane of the core network, or may be integrated in a network element of the user plane, e.g., a User Plane Function (UPF). Based on this, compared with an existing core network architecture of 3GPP, by adding the slice management server on the user plane of the core network, and using the slice management server to control the network slice rule of the UE, a 5G slicing management function can be carried out by the user plane, and thus a 5G slice selection policy can be placed on the AP side, to facilitate a quick coordination between a terminal vendor, an operator and a customer for quick completion of requirement customization of a 5G vertical industry.

In an embodiment, the slice management server may issue the network slice rule to the UE actively or according to a request of the UE.

It should be pointed out that, for the management of the network slice rule of the UE, the slice management server may independently manage the network slice rule of the UE, or may cooperate with a Policy Control Function (PCF) located on the control plane of the core network to manage the network slice rule.

In an embodiment, as shown in FIG. 1C, S102 may include, but not limited to, the following sub-steps S1021 to 1022.

At S1021, a server address is acquired from a network element on the control plane of the core network.

At S1022, a connection is established with the UE through the server address.

In this embodiment, the slice management server acquires the server address from a network element on the control plane of the core network, and the UE establishes a connection with the slice management server through the server address, so that the connection between the slice management server and the UE is established. The network element of the core control plane includes, but not limited to, the PCF. It should be pointed out that the server address may be an IP address or a domain name.

In an embodiment, S103 may include, but not limited to, the following sub-step:

sending the second network slice rule to the UE according to a first network slice rule matching request sent by the UE.

In this embodiment, the UE sends a request to the slice management server, which is the first network slice rule matching request for checking the version of a first network slice rule. The first network slice rule is a network slice rule built in the UE. The slice management server sends the second network slice rule to the UE according to a check result of the request.

In an embodiment, as shown in FIG. 1D, S103 may further include, but not limited to, the following sub-steps S1031 to S1033.

At S1031, the first network slice rule matching request sent by the UE is received.

At S1032, matching the second network slice rule with the first network slice rule built in the UE is performed according to the first network slice rule matching request.

At S1033, if a determination is made that the first network slice rule does not match the second network slice rule, the second network slice rule is sent to the UE.

In this embodiment, the slice management server receives the request sent by the UE, which is the first network slice rule matching request for checking the version of the first network slice rule. The first network slice rule is a network slice rule built in the UE. The slice management server matches, according to the first network slice rule matching request, the second network slice rule with the first network slice rule built in the UE. If a determination is made that the first network slice rule does not match the second network slice rule, that is, it is judged that a current network slice rule built in the UE is not desired by the network, the second network slice rule is sent to the UE to replace the first network slice rule built in the UE.

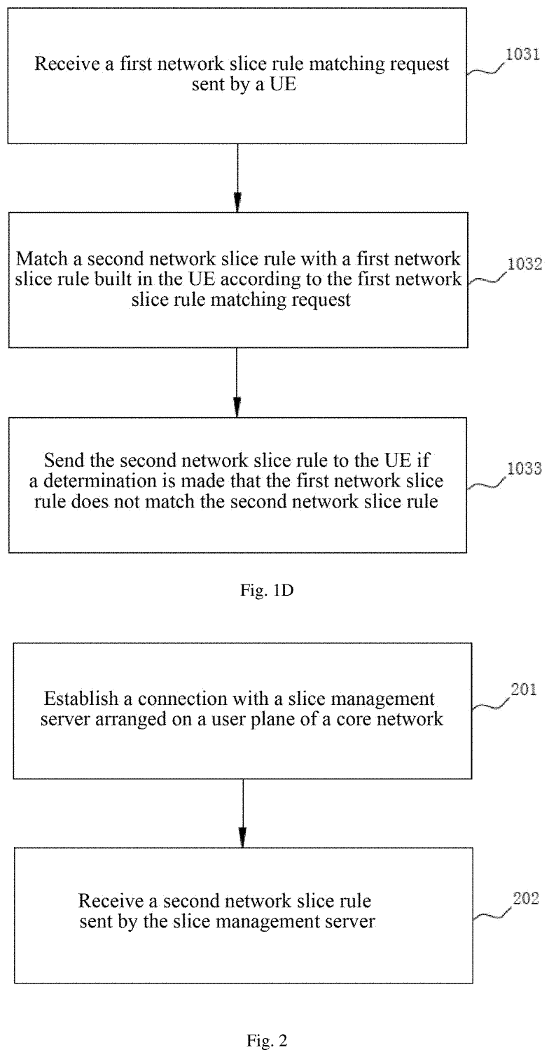

FIG. 2 is a flowchart of a network slice management method according to an embodiment of the present disclosure. As shown in FIG. 2, the network slice management method is applied to a User Equipment (UE). The method includes, but not limited to, the following steps S201 to S202.

At S201, a connection is established with a slice management server arranged on a user plane of a core network.

At S202, a second network slice rule sent by the slice management server is received.

In an embodiment, the UE establishes a connection with the slice management server arranged on the user plane of the core network, and receives the second network slice rule sent by the slice management server. The second network slice rule refers to a new version of network slice rule acquired by the slice management server. In this embodiment, the UE acquires the second network slice rule from the slice management server, and the slice management server is arranged on the user plane of the core network. Therefore, compared with the current core network architecture of 3GPP, the slice management server is used to control the network slice rule of the UE, so that a 5G slicing management function can be carried out by the user plane, and thus a 5G slice selection policy can be placed on the AP side, to facilitate a quick coordination between a terminal vendor, an operator and a customer for quick completion of requirement customization of a 5G vertical industry.

In an embodiment, the method further includes the following step:

when a connection is established with the slice management server arranged on the user plane of the core network, sending a first network slice rule matching request to the slice management server, so that the slice management server sends the second network slice rule to the UE according to the first network slice rule matching request.

In this embodiment, when a connection is established with the slice management server arranged on the user plane of the core network, the UE actively sends a request to the slice management server, which is the first network slice rule matching request for checking the version of a first network slice rule, so that the slice management server sends the second network slice rule to the UE according to the first network slice rule matching request. The first network slice rule is a network slice rule built in the UE.

In an embodiment, the method further includes the following step:

when the second network slice rule sent by the slice management server is received, replacing the first network slice rule built in the UE with the second network slice rule.

In this embodiment, the slice management server matches, according to the first network slice rule matching request, the second network slice rule with the first network slice rule built in the UE. If a determination is made that the first network slice rule does not match the second network slice rule, that is, it is judged that a current network slice rule built in the UE is not desired by the network, the second network slice rule sent by the slice management server is received and used to replace the first network slice rule built in the UE to complete the update of the network slice rule. Thus, when the UE initiates a service connection, a network slice will be selected according to the updated network slice rule to complete the related service connection.

In an embodiment, the method further includes the following step:

encrypting and saving the second network slice rule.

In this embodiment, after the network slice rule is updated, the UE may encrypt and save the updated network slice rule. The UE is not allowed to modify the network slice rule, which can only be modified by the network slice server.

In an embodiment, S201 may further include, but not limited to, the following sub-steps:

acquiring a server address of the slice management server; and

establish a connection with the slice management server through the server address.

In this embodiment, the UE acquires the server address of the slice management server and establishes a connection with the slice management server through the server address, so that the connection between the slice management server and the UE is established. It should be pointed out that the server address may be an IP address or a domain name.

The network slice management method according to the embodiments of the present disclosure will be further illustrated below by taking the slice management server independently controlling the network slicing function of the UE as an example. The method includes the following steps S1 to S8.

At S1, a default network slice built in the UE is used for initiating boot registration.

At S2, a link between a wireless network and a core network is established.

At S3, a PCF issues an IP address of a slice management server.

At S4, an IP connection is established between the slice management server and the UE.

At S5, the slice management server actively issues a network slice rule to the UE, or the UE applies for a check of the content (or version) of a network slice rule, and the slice management server judges, according to a check result, whether to issue a new network slice rule.

At S6, if a current network slice rule of the UE is inconsistent with the network slice rule of the slice management server, the network slice server issues the network slice rule to the UE.

At S7, after update of the network slice rule is complete, the UE encrypts and saves the slice rule, where the UE is not allowed to modify the network slice rule, which can only be modified by the network slice server.

At S8, when the UE initiates a service connection, a network slice is selected according to the network slice rule to complete the related service connection.

Based on this, compared with an existing core network architecture of 3GPP, by adding the slice management server on the user plane of the core network, and using the slice management server to control the network slice rule of the UE, a 5G slicing management function can be carried out by the user plane, and thus a 5G slice selection policy can be placed on the AP side, to facilitate a quick coordination between a terminal vendor, an operator and a customer for quick completion of requirement customization of a 5G vertical industry.

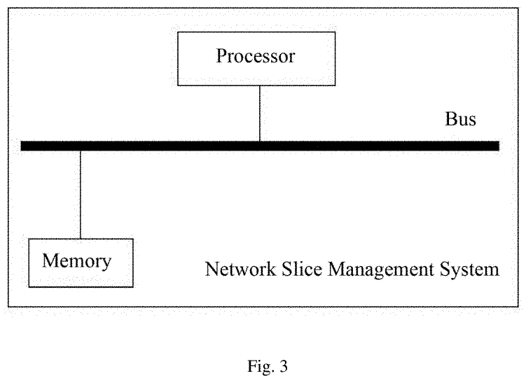

As shown in FIG. 3, an embodiment of the present disclosure further provides a network slice management system.

In an embodiment, the network slice management system includes one or more processors, and a memory. In FIG. 3, one processor and a memory are taken as an example. The processor and the memory may be connected through a bus or other means. In FIG. 3, bus connection is taken as an example.

As a non-transitory computer-readable storage medium, the memory may be configured to store a non-transitory software program and a non-transitory computer-executable program, such as the above network slice management method in the embodiments of the present disclosure. The non-transitory software program and the non-transitory computer-executable program stored in the memory, when executed by the processor, cause the processor to implement the above network slice management method in the embodiments of the present disclosure.

The memory may include a program storage area and a data storage area. The storage program area may store an operating system and an application required by at least one function. The data storage area may store data and the like required for executing the above network slice management methods in the embodiments of the present disclosure. In addition, the memory may include a high-speed random access memory, and may also include a non-transitory memory, e.g. at least one disk storage device, flash memory device or other non-transitory solid-state storage devices. In some embodiments, the memory may include memories disposed remotely relative to the processor, and these remote memories may be connected to the terminal device through a network. Examples of the above network include, but not limited to, the Internet, an intranet, a local area network, a mobile communication network, and combinations thereof.

The non-transitory software program and the non-transitory computer-executable program required for implementing the above network slice management methods in the embodiments of the present disclosure are stored in the memory which, when executed by one or more processors, cause the one or more processors to implement the above network slice management methods in the embodiments of the present disclosure is executed, for example, the steps S101 to S103 in FIG. 1A, the steps S1021 to S1022 in FIG. 1C, the steps S1031 to S1033 in FIG. 1D and the steps S201 to S202 in FIG. 2. By establishing a connection between the slice management server arranged on the user plane of the core network and the UE, the slice management server sends a new version of network slice rule to the UE. Based on this, compared with an existing core network architecture of 3GPP, by adding the slice management server on the user plane of the core network, and using the slice management server to control the network slice rule of the UE, a 5G slicing management function can be carried out by the user plane, and thus a 5G slice selection policy can be placed on the AP side, to facilitate a quick coordination between a terminal vendor, an operator and a customer for quick completion of requirement customization of a 5G vertical industry.

In addition, an embodiment of the present disclosure further provides a computer-readable storage medium, storing a computer-executable program which, when executed by one or more control processors (e.g., one processor in FIG. 3), causes the one or more processors to implement the above network slice management methods in the embodiments of the present disclosure, for example, the steps S101 to S103 in FIG. 1A, the steps S1021 and S1022 in FIG. 1C, the steps S1031 to S1033 in FIG. 1D and the steps S201 and S202 in FIG. 2 described above. By establishing a connection between the slice management server arranged on the user plane of the core network and the UE, the slice management server sends a new version of network slice rule to the User Equipment (UE). Based on this, compared with an existing core network architecture of 3GPP, by adding the slice management server on the user plane of the core network, and using the slice management server to control the network slice rule of the UE, a 5G slicing management function can be carried out by the user plane, and thus a 5G slice selection policy can be placed on the AP side, to facilitate a quick coordination between a terminal vendor, an operator and a customer for quick completion of requirement customization of a 5G vertical industry.

According to the embodiments of the present disclosure, by adding a slice management server on a user plane of a core network, the slice management server establishes a connection with a User Equipment (UE), and the slice management server sends a new version of network slice rule to the UE. Based on this, compared with an existing core network architecture of 3GPP, by adding the slice management server on the user plane of the core network, and using the slice management server to control the network slice rule of the UE, a 5G slicing management function can be carried out by the user plane, and thus a 5G slice selection policy can be placed on the AP side, to facilitate a quick coordination between a terminal vendor, an operator and a customer for quick completion of requirement customization of a 5G vertical industry.

It can be understood by those having ordinary skills in the art that all or some of the steps in the method and the system disclosed above can be implemented as software, firmware, hardware and an appropriate combination thereof. Some or all of the physical components may be implemented as software executed by a processor (such as a central processing unit, a digital signal processor or a microprocessor), hardware or an integrated circuit (such as an application-specific integrated circuit). Such software may be distributed on computer-readable media, which may include computer storage media (or non-transitory media) and communication media (or transitory media). As is well-known to those having ordinary skills in the art, the term “computer storage media” include volatile and nonvolatile, removable and non-removable media implemented in any method or technology for storing information (such as computer-readable programs, data structures, program modules or other data). Computer storage media include, but not limited to, RAMs, ROMs, EEPROMs, flash memories or other memory technologies, CD-ROMs, digital versatile disks (DVDs) or other optical disk storages, magnetic cassettes, magnetic tapes, magnetic disk storages or other magnetic storage devices or any other media that can be used to store desired information and can be accessed by computers. Further, it is well-known to those having ordinary skills in the art that communication media typically contain computer-readable programs, data structures, program modules or other data in a modulated data signal such as carriers or other transmission mechanisms, and may include any information delivery media.

Some embodiments of the present disclosure have been described in detail above, and the present disclosure is not limited thereto. Those having ordinary skills in the art may also make various equivalent modifications or replacements without departing from the protection scope of the present disclosure, and these equivalent modifications or replacements shall be included in the scope defined by the claims of the present disclosure.

What is claimed is:

1. A network slice management method, applied to a slice management server arranged on a user plane of a core network, the method comprising:
acquiring a second network slice rule;
establishing a connection with a user equipment (UE); and
sending the second network slice rule to the UE.

2. The method of claim 1, wherein establishing a connection with a UE comprises:
acquiring a server address from a network element of a control plane of the core network; and
establishing a connection with the UE through the server address.

3. The method of claim 2, wherein the network element of the control plane of the core network is a policy control function (PCF).

4. The method of claim 2, wherein the server address is an IP address or a domain name.

5. The method of claim 1, wherein sending the second network slice rule to the UE comprises:
sending the second network slice rule to the UE according to a first network slice rule matching request sent by the UE.

6. The method of claim 5, wherein sending the second network slice rule to the UE according to a first network slice rule matching request sent by the UE comprises:
receiving the first network slice rule matching request sent by the UE;
matching the second network slice rule with the first network slice rule built in the UE according to the first network slice rule matching request; and
in response to a determination that the first network slice rule does not match the second network slice rule, sending the second network slice rule to the UE.

7. A network slice management method, which is applied to a user equipment (UE), the method comprising:
establishing a connection with a slice management server arranged on a user plane of a core network; and
receiving a second network slice rule sent by the slice management server.

8. The method of claim 7, further comprising:
in response to a connection being established with the slice management server arranged on the user plane of the core network, sending a first network slice rule matching request to the slice management server, so that the slice management server sends the second network slice rule to the UE according to the first network slice rule matching request.

9. The method of claim 8, further comprising:
in response to receiving the second network slice rule sent by the slice management server, replacing the first network slice rule built in the UE with the second network slice rule.

10. The method of claim 9, further comprising:
encrypting and saving the second network slice rule.

11. The method of claim 7, wherein establishing a connection with a slice management server arranged on a user plane of a core network comprises:
acquiring a server address of the slice management server; and
establishing a connection with the slice management server through the server address.

12. The method of claim 11, wherein the server address is an IP address or a domain name.

13. (canceled)

14. A non-transitory computer-readable storage medium, storing a computer-executable program which, when executed by a computer,
causes the computer to perform a network slice management method, applied to a slice management server arranged on a user plane of a core network, the method comprising:
acquiring a second network slice rule;
establishing a connection with a user equipment (UE); and
sending the second network slice rule to the UE; or
causes the computer to perform a network slice management method, which is applied to a user equipment (UE), the method comprising:
establishing a connection with a slice management server arranged on a user plane of a core network; and
receiving a second network slice rule sent by the slice management server.
